(19) United States
(12) Patent Application Publication
(10) Pub. No.: US 2023/0009632 A1
(43) Pub. Date: Jan. 12, 2023

(54) DEVICES WITH FOUND DEVICE ALERT APPLICATIONS

(71) Applicant: Hewlett-Packard Development Company, L.P., Spring, TX (US)

(72) Inventors: Christopher Myers, Vancouver, WA (US); Paul Michael Anderson, Fort Collins, CO (US)

(21) Appl. No.: 17/781,334

(22) PCT Filed: Dec. 12, 2019
(86) PCT No.: PCT/US2019/065948

§ 371 Date: May 31, 2022

(51) Int. Cl. H04M 1/72457; H04M 1/72463; H04W 4/029; H04W 68/00

(52) U.S. Cl. CPC H04M 1/72457; H04M 1/724631; H04W 4/029; H04W 68/005; H04M 2201/42

(57) ABSTRACT

In example implementations, a mobile device is provided. The mobile device includes a button input, a wireless communication interface, a memory, and a processor. The input is to initiate a found device alert application from a locked screen of the mobile device. The wireless communication interface is to send a found device alert notification. The memory is to store user defined third-party contact information and the found device alert application. The processor is to execute the found device alert application in response to a signal generated by the input. The processor is to generate the found device alert notification and cause the wireless communication interface to transmit the found device alert notification to a location indicated by the third-party contact information.

### BACKGROUND

Mobile devices are becoming more ubiquitous. Individuals may carry a variety of mobile devices, such as a cellular telephone, a laptop computer, a tablet computer, a wearable device, and the like. Due to the size and mobility of these devices, many individuals may take these mobile devices when traveling. For example, individuals may take mobile devices to various locations including a library, an airport, a restaurant, a business meeting, a friend’s house, a park, a hotel, and so forth.

### BRIEF DESCRIPTION OF THE DRAWINGS

FIG. 1 is a block diagram of an example device with a found device alert application of the present disclosure;

FIG. 2 is a block diagram of an example a locked screen with the found device alert application icon of the present disclosure;

FIG. 3 is a block diagram of an example user interface of the found device alert application of the present disclosure;

FIG. 4 a flow chart of an example method for sending a found device alert notification of the present disclosure; and

FIG. 5 is a block diagram of an example non-transitory computer readable storage medium storing instructions executed by a processor to send a found device alert notification.

### DETAILED DESCRIPTION

Examples described herein provide devices with a found device alert application. As noted above, many individuals may take mobile devices when traveling. For example, individuals may take mobile devices to various locations including a library, an airport, a restaurant, a business meeting, a friend’s house, a park, a hotel, and so forth. However, children may leave the mobile devices at a restaurant or store, adults may leave the mobile device at an airport or business meeting, and so forth.

Currently, when a mobile device is left behind, a user may utilize a service to locate the device. The service may be able to provide a general geographic location of the device (e.g., when the location tracking is enabled), but may not be able to provide an exact location (e.g., Los Angeles International Airport versus TSA security checkpoint number 2 in terminal 2). Moreover, there is no way to communicate with anyone who may have found the device with the device location services.

Examples herein provide a device and method that allows a finder of a lost device to activate or execute a found device alert application. The application can be launched from a locked screen of the mobile device such that the finder may not be able to access personal or sensitive information that may be stored on the mobile device.

In some examples, an owner of the mobile device may pre-define third party contact numbers into the mobile device or application. For example, if the owner is traveling with a spouse, the owner may store the spouse’s telephone number. When the mobile device is lost and a finder launches the found device alert application, the application may send a message or call the spouse’s telephone number. As a result, the owner of the mobile device can possibly retrieve the device before leaving the location.

In some examples, the third party contact information may include information technology (IT) administrators or other employees of a company if the mobile device is a company device. In addition, certain actions can be pre-defined to be executed in response to the found device alert application being launched. For example, the mobile device may contain company sensitive information and the actions may allow the mobile device to wipe its memory automatically if the mobile device is not returned.

In some examples, the found device alert application may also include a message interface for the finder. Thus, the finder may provide specific information related to the location of the found device. For example, the finder may provide a specific location (e.g., with employee John Doe, at security checkpoint 3 at terminal A, at the lost and found, and so forth). Thus, the message interface may allow the owner to receive more specific information with respect to where the mobile device was left rather than just general location information.

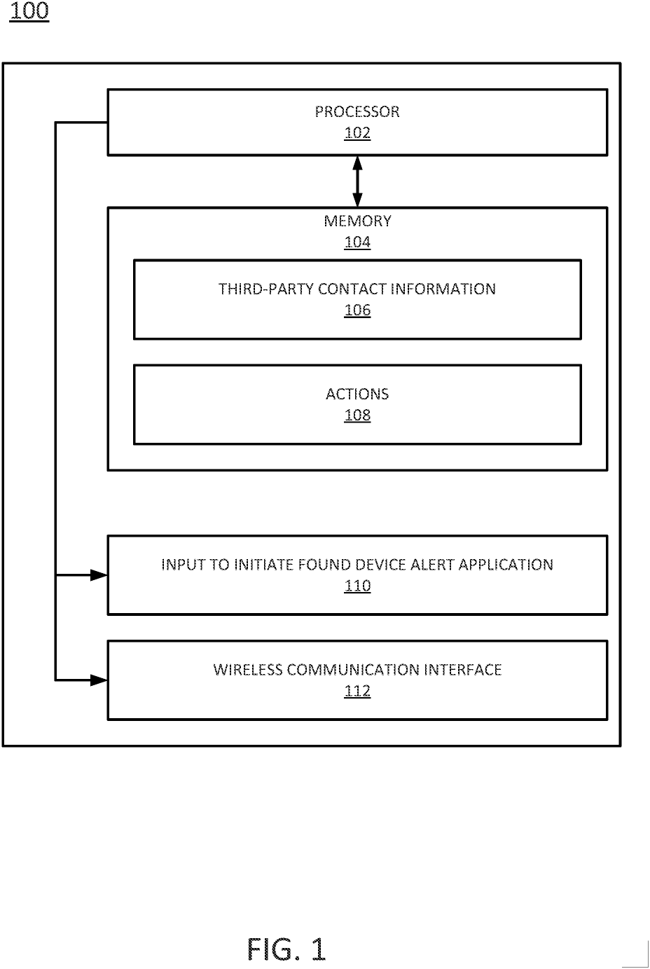

FIG. 1 illustrates an example block diagram of a mobile device 100 of the present disclosure. The mobile device 100 may be a mobile telephone, a laptop computer, a tablet computer, a wearable device, and the like. The mobile device 100 may be any type of device that can communicate wirelessly and have an input (either a physical button or software button) to initiate a found device alert application (FDAA) of the present disclosure.

In one example, the mobile device 100 may include a processor 102, a memory 104, an input 110, and a wireless communication interface 112. The processor 102 may be communicatively coupled to the memory 104, the input 110, and the wireless communication interface 112. The processor 102 may execute instructions stored in the memory 104, receive signals generated by the input 110, and the control operation of the wireless communication interface 112.

In one example, the memory 104 may be a non-transitory computer readable medium. For example, the memory 104 may be a hard disk drive, a solid state drive, a read-only memory (ROM), a random access memory (RAM), and the like. The memory 104 may store third-party contact information 106 and actions 108.

In an example, an owner of the mobile device 100 or an information technology (IT) administrator who works for a company that owns the mobile device 100 may define the third-party contact information 106. For example, the third-party contact information 106 may include contact information for a traveling companion of the owner. For example, the contact information may be a mobile telephone number of a spouse’s cellular telephone, a child’s cellular telephone, and the like. In an example, the third-party contact information 106 may be a mobile telephone number of an employee that is assigned to the mobile device 100, the IT administrator, and the like. In one example, the third-party contact information 106 may also include email addresses.

In one example, the third-party contact information 106 may also be pre-defined to include contact information for other devices that a user may carry. For example, the third-party contact information 106 may include an email address of the owner of the mobile device 100, the cellular telephone number of the owner that may be answered on a connected wearable device (e.g., a watch with cellular communication capabilities or a fitness monitoring watch), a cellular telephone of a second mobile device that the owner may carry, and so forth.

In some examples, the owner of the mobile device 100 may update the third-party contact information 106 periodically or based on who the owner is travelling with. For example, if the owner is with his or her family, the owner may update the third-party contact information 106 with the contact information of his or her family members. If the owner is traveling on business, the owner may update the third-party contact information 106 with contact information of co-workers with whom the owner is travelling. Thus, the third-party contact information 106 may be changed as the people who may be with the owner change.

As will be discussed in further details below, the third-party contact information 106 may allow the mobile device 100 to transmit a notification to the contacts stored in the third-party contact information 106 if the mobile device 100 is left behind and found by another individual. By sending a message to someone stored in the third-party contact information 106, there is a better chance for the owner to retrieve the mobile device 100 that may be left behind before leaving a particular location where the mobile device 100 was left behind. However, the third party contact information 106 may be kept hidden from an individual who finds the mobile device 100. Thus, the third party contact information 106 can be used by the mobile device 100 to allow the individual who finds the mobile device 100 to contact the owner without revealing the third party contact information.

In one example, the actions 108 may be pre-defined by the owner or an IT administrator. The actions 108 may define steps that should be executed in response to activation or execution of the found device alert application. The actions 108 may include time thresholds for when the actions should be executed in the event the mobile device 100 is not retrieved or returned. For example, the mobile device 100 may be a company owned mobile device that includes sensitive information. Thus, the IT administrator can define the actions 108 to wipe the memory 104 clear if the mobile device 100 is not returned within 24 hours of the found device alert application being initiated.

In some examples, the actions 108 may have a tiered escalation. For example, the mobile device 100 may lock all communication interfaces (e.g., universal serial bus (USB) connections, communication interfaces, external ports, power ports, and the like) remotely after 24 hours of the found device alert application being initiated. The actions 108 may then power down the mobile device 100 after 48 hours of the found device alert application being initiated. The actions 108 may then delete all contents in the memory 104 after 72 hours of the found device alert application being initiated, and so forth.

In one example, the input 110 may be an input to initiate the found device alert application. As discussed in further details below, the input 110 may be a physical button, a software input on a graphical user interface (GUI), a sequence of buttons, and the like. The input 110 may generate a signal to cause the processor 102 to initiate the found device alert application.

In one example, the wireless communication interface 112 may allow data to be transmitted wirelessly to devices associated with the contact information stored in the third-party contact information 106. The wireless communication interface 112 may be a cellular radio, a Wi-Fi radio, and the like.

It should be noted that the mobile device 100 has been simplified for ease of explanation and may include other components not shown. For example, the mobile device 100 may also include global positioning satellite (GPS) device. The GPS device may detect a location of the mobile device 100 (e.g., GPS coordinates). The mobile device 100 may also include other components such as a battery, various input/output ports, speakers, and the like.

In one example, the third party contact information 106 and the actions 108 may be stored in a remotely located server or “cloud” service. For example, the owner of the mobile device 100 may enter the third party contact information 106 via the mobile device 100. The third party contact information may be then transmitted to the remotely located server. In another example, an IT administrator may modify the third party contact information 106 for the mobile device 100 (as well as other mobile devices managed by the IT administrator) via the remotely located server. The third party contact information 106 may then be pushed out to the respective mobile devices 100 or pulled by the respective mobile devices 100.

Subsequently, when an individual finds the mobile device 100, the found device alert application may notify the remotely located server. The remotely located server may then transmit the appropriate notifications to the third party contact information 106 and/or exchange the messages between the found mobile device 100 and the device associated with the third party contact information 106.

In addition, the actions 108 may be executed remotely by the remotely located server. The actions 108 may be defined by an IT administrator and the actions 108 may be initiated by the remotely located server. Thus, portions of the present disclosure may be offloaded as part of a “cloud” service or may be implemented entirely on the mobile device 100.

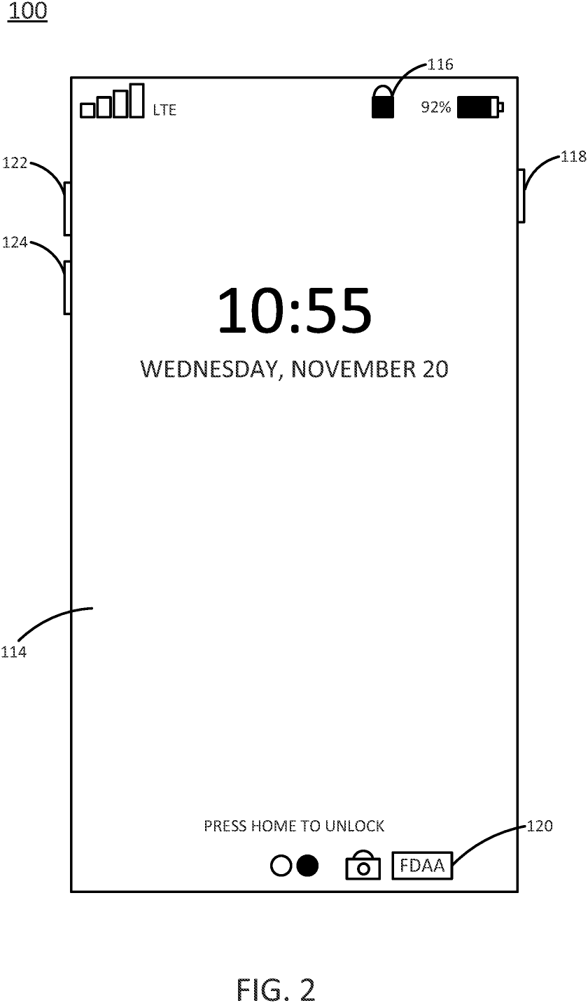

FIG. 2 illustrates an example of a display 114 of the mobile device 100. FIG. 2 illustrates the display 114 in a locked screen mode as indicated by a lock icon 116. In one example, when the mobile device 100 is lost, the mobile device 100 may be in the locked screen mode. Thus, an individual who finds the mobile device 100 (also referred to as a “finder”) may not be able to access information stored in the mobile device 100. Moreover, the finder may not be able to call or message from the locked screen mode.

In one example, the mobile device 100 of the present disclosure may provide an input 110 to allow a finder to launch a found device alert application of the present disclosure. In one example, the input 110 may be a physical button 118. The physical button 118 may be added to the mobile device 100 or may be an existing button that functions as the input 110 in the locked screen mode. In one example, the input 110 may be a software button 120 that causes the found device alert application to be initiated. For example, the display 114 may be a touch screen. The memory 104 may include instructions to generate the software button 120 that can be shown on the display 114 during the locked screen mode.

In another example, the input 110 may be a sequence of button presses of existing buttons. For example, a volume up button 122 and a volume down button 124 may be pressed in a particular sequence to provide the input 110 to initiate the found device alert application. For example, the sequence may be to press the volume up button 122 and the volume down button 124 at the same time for three seconds or more. In another example, the sequence may be to press the volume up button 122 twice and quickly press the volume down button 124 once. A variety of other sequences of existing physical buttons may be also used and are within the scope of the present disclosure.

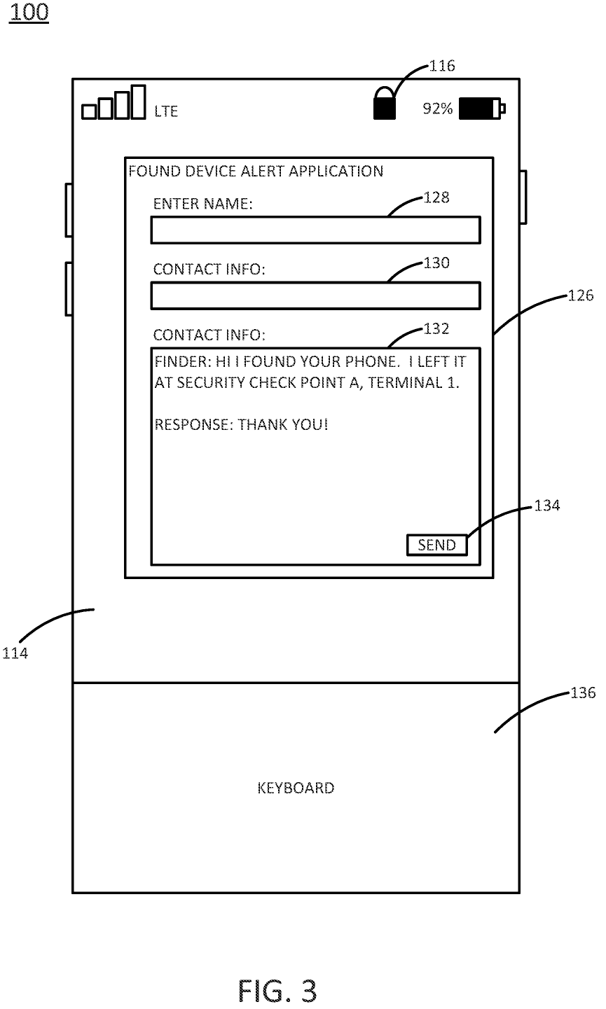

FIG. 3 illustrates an example of a GUI 126 of the found device alert application that may be launched when the input 110 is selected. The GUI 126 may be launched and displayed from the locked screen mode. For example, FIG. 3 still illustrates the lock icon 116 being engaged, indicating that the mobile device 100 is still locked.

In one example, the GUI 126 may include a field 128 to provide a name of the finder, a field 130 to provide contact information of the finder, and a message interface 132. In one example, the finder may enter his or her name in the field 128 so that the owner of the mobile device 100 may know who found the mobile device 100.

In one example, the contact information may be a cellular telephone number or an email address. In an example, an owner may provide a finder’s fee for finding the lost mobile device 100. The contact information may allow the finder’s fee to be automatically sent via an electronic transfer or payment to the contact information. For example, the found device alert application may be linked to an electronic payment application. When the contact information is provided in the field 130 and the owner confirms recovery of the mobile device 100, the electronic payment may be automatically sent to the finder via the electronic payment application linked to the found device alert application.

In one example, the found device alert application may still operate if the finder elects not to provide name and contact information. For example, some individuals may not want to provide name and contact information to a stranger.

In one example, the message interface 132 allows the finder to send a message to the devices associated with the third-party contact information 106 stored in the memory. For example, when the GUI 126 is displayed, a keyboard GUI 136 may also be displayed in the locked screen mode. After a message is typed, the finder may select a send button 134 to transmit the message. Thus, the finder may type a message into the message interface 132.

The message interface 132 may allow the finder to provide a more detailed description of where the mobile device 100 may be located. For example, existing device location services may provide general GPS coordinates or an address of a building. However, a user (e.g., the device owner) may still not know where in the building the device is or who currently is holding the device. However, with the message interface 132, the finder may provide details regarding the exact location. For example, the finder may provide a message indicating a particular person, security desk, terminal at an airport, a floor of a building, a description of a landmark or thing that the mobile device 100 may be left near or hidden behind, and so forth. Thus, when the owner of the mobile device 100 arrives at the location, the owner may know where to go or who to contact at the location to retrieve the lost mobile device 100.

In one example, the message interface 132 may allow messages to be sent back to the finder. For example, since the mobile device 100 is locked, the finder may be unable to read text messages that are sent to the mobile device 100. The message interface 132 of the found device alert application may re-route messages to the message interface 132 of the GUI 126.

To illustrate, a finder may find a lost mobile device 100. The finder may initiate the found device alert application by selecting the software button 120 from the locked screen. In response, the GUI 126 of the found device alert application may be displayed on the locked screen. The finder may enter a message in the message interface 132 indicating where the mobile device 100 may be left.

When the finder selects the send button 134, the mobile device 100 may access the third-party contact information 106 stored in the memory 104. A notification may be generated that includes the message and a GPS location of the mobile device 100. The notification may then be transmitted by the wireless communication interface 112 to the devices associated with the contact information found in the third-party contact information.

In one example, a third-party contact information may be a telephone number of a mobile phone of a spouse of the owner of the mobile device 100. The mobile phone of the spouse may receive the notification. For example, the notification may be sent as a text message. In response, the spouse may reply to the message indicating they will be there to retrieve the mobile device 100. When the reply is received by the mobile device 100, the reply message may be copied or transferred into the message interface 132 for the finder to see. Thus, the finder may wait until the owner arrives rather than leaving the mobile device 100.

In one example, the found device alert application may also include a photograph of the owner such that the finder may know that the correct person is retrieving the mobile device 100. For example, an icon may be presented that links to a photograph of the owner stored on the mobile device 100.

Thus, the present disclosure provides a mobile device 100 that includes a found device alert application. When the mobile device 100 is lost, a finder may open the found device alert application from a locked screen of the mobile device 100. The found device alert application may allow the finder to provide a detailed message to third-party contacts who may be travelling with, or know, the owner of the mobile device 100. Thus, when the third-party is notified, the third-party may presumably let the owner know. In some instances, the found device alert application may also send a notification to other devices of the owner of the mobile device 100. Thus, the owner may be immediately notified before leaving a location where the mobile device 100 is left behind. The found device alert application may also include actions that can be taken automatically in case the mobile device 100 is not retrieved.

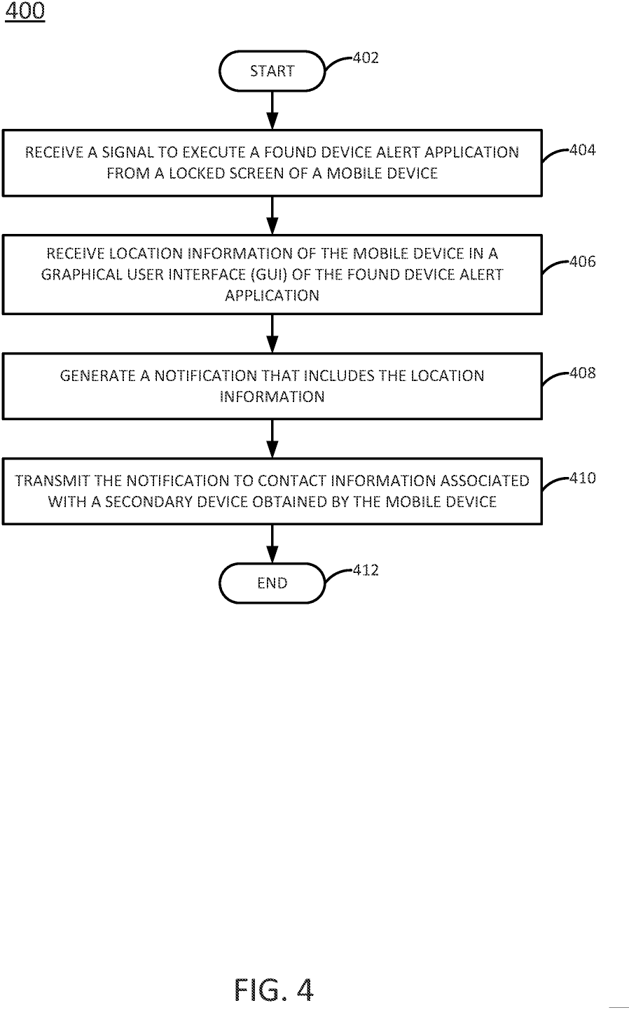

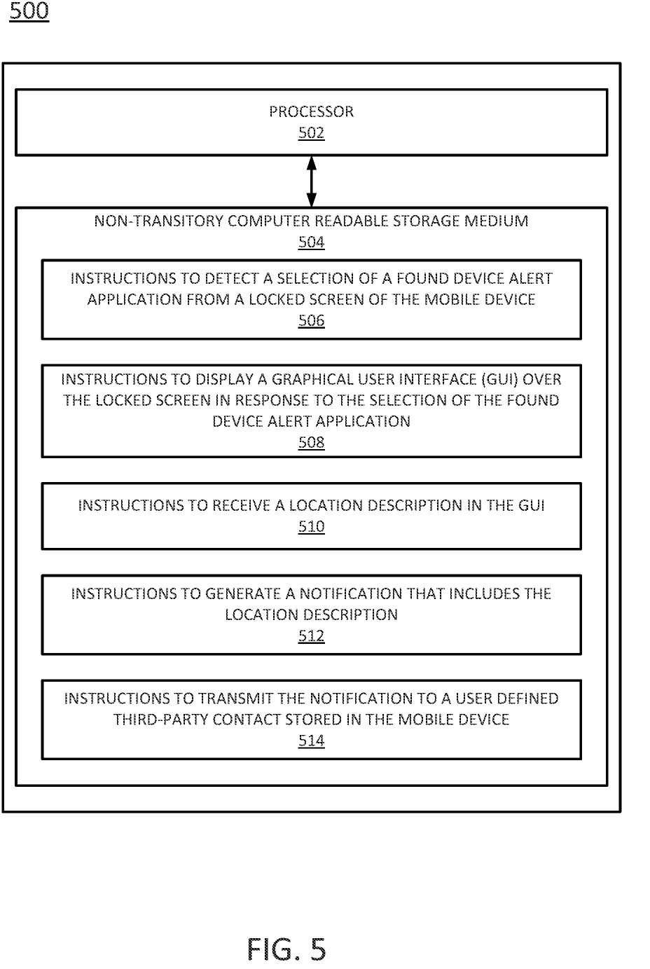

FIG. 4 illustrates a flow diagram of an example method 400 for sending a found device alert notification of the present disclosure. In an example, the method 400 may be performed by the mobile device 100 or the apparatus 500 illustrated in FIG. 5, and described below.

At block 402, the method 400 begins. At block 404, the method 400 receives a signal to execute a found device alert application from a locked screen of the mobile device. For example, the signal may be generated by an input that is selected. The input may be a physical button, a software button on a graphical user interface of the display, a sequence of buttons, and the like.

In response to the signal, the found device alert application may be executed or launched. The found device alert application may include a graphical user interface that is displayed while the mobile device is locked. Thus, the finder may interact with the found device alert application without accessing any other applications, data, contact information, and the like that may be stored on the mobile device.

The found device alert application may include various fields and a message interface. The finder may provide name and contact information that can be used to provide a finder’s fee electronically to the finder.

At block 406, the method 400 receives location information of the mobile device in a graphical user interface (GUI) of the found device alert application. In one example, the location information may be a detailed description of where the mobile device may be left by the finder. The finder may provide details in a message interface of the GUI. For example, the details may be more than just the GPS location and/or an address of a building. The finder may provide information such as a particular person with whom the mobile device is left, a particular terminal number, a particular building number, a floor in the building, a room number in the building, an object that the mobile device is left near, a landmark, and the like. Thus, the location information provided in the GUI by the finder may be more detailed than GPS location information and/or an address.

At block 408, the method 400 generates a notification that includes the location information. In one example, the notification may include the detailed location information provided by the finder in the message interface of the GUI of the found device alert application. In one example, the notification may also include a name of the finder and contact information of the finder. The contact information may be an email address or a telephone number of the finder. The notification may be a text message or an automated telephone call containing the location information.

At block 410, the method 400 transmits the notification to contact information associated with a secondary device obtained by the mobile device. In an example, the contact information may be associated with a third-party contact. The third party-contact can be stored on the local memory of the mobile device. In an example, the third-party contact can be stored on a remotely located server. The third-party contact information can then be pushed out to or pulled in by the mobile device.

In an example, the contact associated with the secondary device may be a secondary device of the owner of the lost mobile device. As noted above, the third-party contact information may include contact information for other devices that an owner of the lost mobile device may carry. For example, an email address that the owner may access on a laptop computer, a telephone number of a second cellular telephone, contact information of a wearable device, and so forth.

In an example, the owner or an IT administrator of the mobile device may define the third-party contact information stored in the mobile device. The third-party contact information may be updated with contact information associated with individuals with whom the owner may be travelling. The third-party contact information may be associated with family members or friends who are in regular contact with the owner. The third-party contact information may be associated with employees or other IT personnel who should be notified when the mobile device 100 is lost. The third-party contact information may include a telephone number or email address associated with the third-party contacts.

In an example, the notification may be sent to the remotely located server. The remotely located server may then distribute the message to the devices associated with the third-party contact. For example, the remotely located server may be managed by an IT administrator of an enterprise that manages the devices of the enterprise. Thus, the IT administrator may monitor the messages via the remotely located server when devices are lost and found.

In one example, when the notification is received by a third-party contact, the third-party contact may respond with a message (e.g., a text message). The message may be received by the mobile device and displayed on the GUI of the found device alert application from a locked screen of the mobile device. Thus, the third-party may communicate with the finder on behalf of the owner of the mobile device.

In one example, additional notifications may be transmitted to other devices associated with an owner of the mobile device. For example, the notification may be an email sent to an email address of the owner. In one example, the notification may be a message sent to the mobile phone number associated with the owner of the mobile device. For example, some devices may be linked and may be capable of receiving the notifications that are sent to the telephone number associated with the mobile device. In one example, the notification may be sent to a wearable device (e.g., a watch with cellular capability, a fitness tracking device, and so forth).

In one example, if the owner is able to retrieve the mobile device, an electronic payment may be sent to the finder using the contact information of the finder that was provided in the GUI of the found device alert application. For example, the owner may close the found device alert application (e.g., via a confirmation code, selecting a confirm button that is displayed after the owner unlocks the mobile device, and so forth). In response, the mobile device may automatically initiate an electronic payment to the contact information of the finder via an electronic payment application linked to the found device alert application.

In one example, the mobile device may track a time duration since the found device alert application was initiated. As a result, if the mobile device is not retrieved by the owner within a predefined period of time, an action or multiple tiered actions may be executed automatically. For example, if the mobile device is not retrieved within a time threshold, the memory of the mobile device may be deleted. At block 412, the method 400 ends.

FIG. 5 illustrates an example of an apparatus 500. In an example, the apparatus 500 may be the mobile device 100. In an example, the apparatus 500 may include a processor 502 and a non-transitory computer readable storage medium 504. The non-transitory computer readable storage medium 504 may include instructions 506, 508, 510, 512, and 514 that, when executed by the processor 502, cause the processor 502 to perform various functions.

In an example, the instructions 506 may include instructions to detect a selection of a found device alert application from a locked screen of the mobile device. The instructions 508 may include instructions to display a graphical user interface (GUI) over the locked screen in response to the selection of the found device alert application. The instructions 510 may include instructions to receive a location description in the GUI. The instructions 512 may include instructions to generate a notification that includes the location description.

The instructions 514 may include instructions to transmit the notification to a user defined third-party contact stored in the mobile device.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A mobile device, comprising:
an input to initiate a found device alert application from a locked screen of the mobile device;
a wireless communication interface to send a found device alert notification;
a memory to store user defined third-party contact information and the found device alert application; and
a processor to execute the found device alert application in response to a signal generated by the input wherein the processor is to generate the found device alert notification and cause the wireless communication interface to transmit the found device alert notification to a location indicated by the third-party contact information.

2. The mobile device of claim 1, further comprising:
a display to generate a graphical user interface (GUI) of the found device alert application.

3. The mobile device of claim 2, wherein the GUI comprises a message interface to receive a detailed location of the mobile device.

4. The mobile device of claim 2, wherein the GUI comprises a contact information field to allow a finder to enter contact information.

5. The mobile device of claim 1, wherein the input comprises a physical button.

6. The mobile device of claim 1, wherein the input comprises a touch screen and the memory includes instructions to generate a software button on the locked screen.

7. The mobile device of claim 1, wherein the memory is to store mobile device actions to be executed in response to execution of the found device alert application.

8. A method, comprising:
receiving, by a processor of a mobile device, a signal to execute a found device alert application from a locked screen of the mobile device;
receiving, by the processor, location information of the mobile device in a graphical user interface (GUI) of the found device alert application;
generate, by the processor, a notification that includes the location information; and
transmitting, by the processor, the notification to contact information associated with a secondary device obtained by the mobile device.

9. The method of claim 8, further comprising:
receiving, by the processor, the contact information of a finder of the mobile device via the GUI;
transmitting, by the processor, an electronic payment to the finder via the contact information of the finder.

10. The method of claim 8, wherein the contact information is obtained from a remotely located server.

11. The method of claim 8, wherein the transmitting comprises:
transmitting, by the processor, the notification to a remotely located server, wherein the remotely located server is to direct messages between the mobile device and a device associated with the contact information.

12. The method of claim 8, further comprising:
receiving, by the processor, a message in response to the notification, wherein the message is displayed on the GUI of the found device alert application displayed from a locked screen of the mobile device.

13. A non-transitory computer readable storage medium encoded with instructions executable by a processor of a mobile device, the non-transitory computer-readable storage medium comprising:
instructions to detect a selection of a found device alert application from a locked screen of the mobile device;
instructions to display a graphical user interface (GUI) over the locked screen in response to the selection of the found device alert application;
instructions to receive a location description in the GUI;
instructions to generate a notification that includes the location description; and
instructions to transmit the notification to a user defined third-party contact stored in the mobile device.

14. The non-transitory computer readable storage medium of claim 13, further comprising:
instructions to track a time duration since the found device alert application was detected; and
instructions to execute an action when the time duration exceeds a threshold.

15. The non-transitory computer readable storage medium of claim 14, wherein the action comprises deleting a memory of the mobile device.
